(19) United States
(12) Patent Application Publication
(10) Pub. No.: US 2004/0196225 A1
(43) Pub. Date: Oct. 7, 2004

(54) Driving apparatus, lighting apparatus using the same, and display apparatus using the lighting apparatus

(75) Inventor: Naoto Shimada, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Shibuya-ku (JP)

(21) Appl. No.: 10/816,100

(22) Filed: Apr. 1, 2004

(30) Foreign Application Priority Data
Apr. 4, 2003 (JP) 2003-101649

(51) Int. Cl. G09G 3/32

(52) U.S. Cl. 345/82

(57) ABSTRACT

A driving apparatus which drives a load by switching driving conditions with time comprises a load driving section, a switching section, and a control section. The load driving section drives the load by supplying a voltage and a current. The switching section switches conditions of the load driven by the load driving section. The control section obtains load characteristic information after switching by the switching section before the switching, and sets a voltage and a current by which the load driving section drives the load to a voltage and a current corresponding to the load characteristic information after the switching in synchronization with timing of the switching.

### CROSS-REFERENCE TO RELATED APPLICATIONS

This application is based upon and claims the benefit of priority from prior Japanese Patent Application No. 2003-101649, filed Apr. 4, 2003, the entire contents of which are incorporated herein by reference.

### BACKGROUND OF THE INVENTION

1. Field of the Invention

The present invention relates to a driving apparatus which supplies, in a power source for making selection among a plurality of loads to be preferably driven by a constant current and executing driving by time-sequential switching, a driving voltage and a driving current to execute stable driving corresponding to the switching and to drive the selected load by high energy use efficiency. Moreover, the present invention relates to a lighting apparatus using such a driving apparatus, and a display apparatus using the lighting apparatus.

2. Description of the Related Art

U.S. Pat. No. 6,466,188 discloses an LED power circuit which generates a voltage value suited to constant-current driving of a light emitting diode (referred to as LED, hereinafter) based on a given set value at a DC-DC converter. This power circuit is configured to drive an LED based on a set driving current value even if the LED which has a different forward voltage (V_{f}) is connected. That is, the driving current value of the LED is fed back to the DC-DC converter by a feedback system constituted of an OP amplifier to be made variable therein. Thus, no matter what kinds of LEDs are connected, it is possible to drive the LEDs with good energy efficiency.

Additionally, Jpn. Pat. Appln. KOKAI Publication No. 11-32278 discloses a projector of RGB field sequential color displaying which uses LEDs of R, G, B colors to be switched for lighting at a high speed as a light source. As a power circuit for this projector, application of the power circuit disclosed in the U.S. Pat. No. 6,466,188 may be considered. In other words, a configuration may be employed in which a changeover switch (referred to as SW, hereinafter) is controlled by an LED lighting controller, and an LED to be driven is selected from a plurality of LEDs to be used.

### BRIEF SUMMARY OF THE INVENTION

According to a first aspect of the present invention, there is provided a driving apparatus which drives a load by switching driving conditions with time, comprising:

a load driving section configured to drive the load by supplying a voltage and a current;

a switching section configured to switch conditions of the load driven by the load driving section; and

a control section configured to obtain load characteristic information after switching by the switching section before the switching, and to set a voltage and a current by which the load driving section drives the load to a voltage and a current corresponding to the load characteristic information after the switching in synchronization with timing of the switching.

According to a second aspect of the present invention, there is provided a lighting apparatus which lights a display device displayed by a video signal, comprising:

a driving apparatus which drives a load by switching driving conditions with time, including:

a load driving section configured to drive the load by supplying a voltage and a current;

a switching section configured to switch conditions of the load driven by the load driving section; and

a control section configured to obtain load characteristic information after switching by the switching section before the switching, and to set a voltage and a current by which the load driving section drives the load to a voltage and a current corresponding to the load characteristic information after the switching in synchronization with timing of the switching; and

a light emitter configured as a load driven by the load driving section to light the display device, wherein

the switching section selects the light emitter driven in synchronization with timing of the video signal.

According to a third aspect of the present invention, there is provided a display apparatus comprising:

a display device configured to display a video by a video signal; and

a lighting apparatus which lights the display device, including:

a driving apparatus which drives a load by switching driving conditions with time, having:

a load driving section configured to drive the load by supplying a voltage and a current;

a switching section configured to switch conditions of the load driven by the load driving section; and

a control section configured to obtain load characteristic information after switching by the switching section before the switching, and to set a voltage and a current by which the load driving section drives the load to a voltage and a current corresponding to the load characteristic information after the switching in synchronization with timing of the switching; and

a light emitter configured as a load driven by the load driving section to light the display device, wherein

the switching section selects the light emitter driven in synchronization with timing of the video signal.

According to a fourth aspect of the present invention, there is provided a driving apparatus which drives a load by switching driving conditions with time, comprising:

load driving means for driving the load by supplying a voltage and a current;

switching means for switching conditions of the load driven by the load driving means; and

control means for obtaining load characteristic information after switching by the switching means before the switching, and setting a voltage and a current by which the load driving means drives the load to a voltage and a current corresponding to the load characteristic information after the switching in synchronization with timing of the switching.

According to a fifth aspect of the present invention, there is provided a lighting apparatus which lights a display device displayed by a video signal, comprising:

a driving apparatus which drives a load by switching driving conditions with time, including:

load driving means for driving the load by supplying a voltage and a current;

switching means for switching conditions of the load driven by the load driving means; and

control means for obtaining load characteristic information after switching by the switching means before the switching, and setting a voltage and a current by which the load driving means drives the load to a voltage and a current corresponding to the load characteristic information after the switching in synchronization with timing of the switching; and

light emitting means, as a load driven by the load driving means, for lighting the display device, wherein

the switching means selects the light emitting means driven in synchronization with timing of the video signal.

According to a sixth aspect of the present invention, there is provided a display apparatus comprising:

a display device configured to display a video by a video signal; and

a lighting apparatus which lights the display device, including:

a driving apparatus which drives a load by switching driving conditions with time, including:

load driving means for driving the load by supplying a voltage and a current;

switching means for switching conditions of the load driven by the load driving means; and

control means for obtaining load characteristic information after switching by the switching means before the switching, and setting a voltage and a current by which the load driving means drives the load to a voltage and a current corresponding to the load characteristic information after the switching in synchronization with timing of the switching; and

light emitting means, as a load driven by the load driving means, for lighting the display device, wherein

the switching means selects the light emitting means driven in synchronization with timing of the video signal.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a configuration of a driving apparatus and a lighting apparatus using the same according to a first embodiment of the present invention;

FIG. 2 is a block diagram showing a configuration of Modified Embodiment 1 of the driving apparatus and the lighting apparatus using the same of the first embodiment;

FIG. 3 is a flowchart explaining an adjustment operation in Modified Embodiment 1;

FIG. 4 is a block diagram showing a configuration of Modified Embodiment 2 of the driving apparatus and the lighting apparatus using the same of the first embodiment;

FIG. 5 is a flowchart explaining an adjustment operation in Modified Embodiment 2;

FIG. 6 is a block diagram showing a configuration of Modified Embodiment 3 of the driving apparatus and the lighting apparatus using the same of the first embodiment;

FIG. 7 is a view showing a relation between a driving current I and an emission amount L by each LED of R, G, B colors;

FIG. 8 is a view showing a relation between a driving current I_{f} and V_{f} by each LED of R, G, B colors;

FIG. 9 is a view showing a configuration of an LED lighting controller in the driving apparatus of the first embodiment;

FIG. 10 is a view showing a configuration of a voltage value variable DC power circuit in the driving apparatus of the first embodiment;

FIG. 11 is a block diagram showing a configuration example of a voltage variable constant voltage control circuit in the voltage value variable DC power circuit of FIG. 10;

FIG. 12 is a block diagram showing another configuration example of the voltage variable constant voltage control circuit in the voltage value variable DC power circuit of FIG. 10;

FIG. 13 is a view showing another configuration example of a voltage value DC power circuit in the driving apparatus of the first embodiment;

FIG. 14 is a view showing a configuration of a current value variable constant current circuit in the driving apparatus of the first embodiment;

FIG. 15 is a view showing another configuration example of the current value variable constant current circuit in the driving apparatus of the first embodiment;

FIG. 16 is a view showing a specific example of a detection unit in Modified Embodiment 1 of the driving apparatus of the first embodiment;

FIG. 17 is a view showing another specific example of a detection unit in Modified Embodiment 1 of the driving apparatus of the first embodiment;

FIG. 18 is a view showing driving timing of an RGB-LED lighting apparatus as a lighting apparatus which uses a driving apparatus according to a second embodiment of the present invention;

FIG. 19 is a view showing a configuration of a display apparatus which uses a rod operation type lighting unit using a plurality of LEDs according to a third embodiment of the present invention;

FIG. 20 is an outline view of the rod operation type lighting apparatus of FIG. 19 seen from a stacked lens side;

FIG. 21 is a view showing a connection circuit between a part of an LED driving power source used in the display apparatus of FIG. 19 and an LED of a load;

FIG. 22 is a timing chart explaining a control state of a period in which an LED of an R color of the LED driving power source used in the display apparatus of FIG. 19 emits a light; and

FIG. 23 is a timing chart specific to one LED of FIG. 22.

### DETAILED DESCRIPTION OF THE INVENTION

Next, embodiments of the present invention will be described with reference to the accompanying drawings.

[First Embodiment]

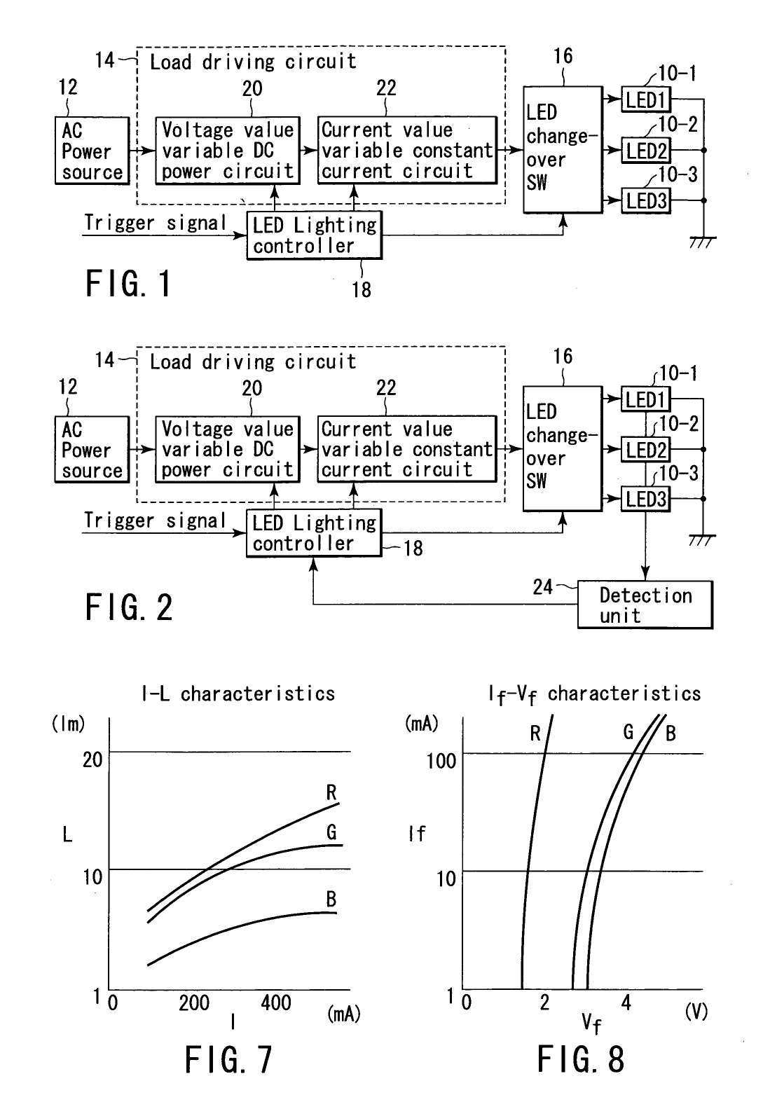

As shown in FIG. 1, a driving apparatus of a first embodiment of the present invention uses LEDs 10 (LEDs 10-1 to 10-3) as light emitters, and a lighting apparatus of the first embodiment of the invention is incorporated in the driving apparatus. In the specifications, the driving apparatus is a term which includes a power source device.

That is, the driving apparatus of the embodiment is arranged between the LED 10 as a load driven while driving conditions are switched with time and an AC power source 12. This driving apparatus comprises a load driving circuit 14 as a load driving section, an LED changeover SW 16 as a switching section, and an LED lighting controller 18 as a control section. The load driving circuit 14 includes a voltage value variable DC power circuit 20 and a current value variable constant current circuit 22.

Here, the voltage value variable DC power circuit 20 converts an AC voltage from the AC power source 12 into a DC voltage. For example, this is a DC stabilization power circuit which can vary an output voltage value in accordance with external control by the LED lighting controller 18. Additionally, the current value variable constant current circuit 22 can vary a constant current value supplied to the load in accordance with the external control by the LED lighting controller 18.

The LED changeover SW 16 selectively supplies driving currents from the current value variable constant current circuit 22 to the plurality of LEDs 10-1 to 10-3 which stably emit lights by constant current driving under control of the LED lighting controller 18. That is, the LED lighting controller 18 generates timing for switching an LED to be driven based on an input trigger signal. Then, the LED changeover SW 16 is controlled to switch driving of the LEDs 10-1 to 10-3 at the timing. Further, the LED lighting controller 18 prestores design values of a driving current value and a voltage value or measured values obtained by experimental evaluation which are proper for the plurality of LEDs 10-1 to 10-3. Then, control is carried out so that a voltage value and a constant current value supplied by the load driving circuit 14 which includes the voltage value variable DC power circuit 20 and the current value variable constant current circuit 22 can be proper for the LEDs. This control is executed by supplying the prestored design values or the design values based on the measured values to the voltage value variable DC power circuit 20 and the current value variable constant current circuit 22 of the load driving circuit 14.

Next, description will be made of an operation of the driving apparatus configured in the foregoing manner. If a driving current value of the LED 10 is I, an optimal value V_{best} of a voltage value set by the voltage value variable DC power circuit 20 is calculated by the following equation:

V_{best}(I)=V_{dr}(I)+Vₛ(I)+V_{f}(I)

wherein V_{dr}(I) is a minimum value of a lowered voltage value between an input and an output of the current value variable constant current circuit 22 to enable its correct driving when the current value is I. V_{f}(I) is a forward voltage of the LED when the current value is similarly I. Vₛ(I) indicates a voltage lowering amount which occurs between an input and an output of the LED changeover SW 16 when the current value is I.

If a supplied voltage value at the voltage value variable DC power circuit 20 is larger than the optimal value V_{best}, a lowered voltage between the input and the output of the current value variable constant current circuit 22 becomes large, and energy of the voltage lowering is discharged substantially as heat which constitutes an energy loss.

The set voltage value is preferably V_{best}(I)+α in consideration of variance in circuits, loads (LEDs). Here, α is a margin value.

For the load driving circuit 14, the LED lighting controller 18 can control the voltage value and the constant current value individually at different timing. Since driving current values proper for the LEDs 10-1 to 10-3 as loads and the forward voltage (V_{f}) in this case are known, a power voltage value which limits an energy loss to a minimum can be set. Accordingly, the LED driving apparatus of high energy use efficiency is realized to reduce the amount of heat generated therein.

Thus, according to the driving apparatus of the embodiment, the LED lighting controller 18 can figure out a value of a control amount of its own voltage value, current value or the like at timing before switching of load conditions by the LED changeover SW 16. Hence, a value of an own control amount can be selected before switching timing, and a proper control method can be employed for the load driving circuit 14. Therefore, it is possible to configure the driving apparatus which can stably drive the LED as a load and which has high energy use efficiency.

Incidentally, according to the embodiment, the LED changeover SW 16 selects one of the three LEDs 10-1 to 10-3. However, use of one LED to be turned ON/OFF may be considered.

Moreover, according to the embodiment, the LED lighting controller 18 supplies the set current and voltage values to the load driving circuit 14 in order to vary voltage and current values output from the load driving circuit 14. As the load driving circuit 14, it is possible to use a circuit which controls varying of the supplied voltage or current value by a frequency. In such a case, the LED lighting controller 18 supplies a frequency value to the load driving circuit 14.

[Modified Embodiment 1]

The driving apparatus of the embodiment may comprise a detection unit 24 as a detection unit to detect driving characteristics of the LEDs 10-1 to 10-3 as shown in FIG. 2. Here, the detection unit 24 has a function of converting an analog value into a digital value at an A/D converter: the analog value being obtained by converting V_{f} of the LEDs 10-1 to 10-3 or the LED driving current value into a voltage at detection resistance. According to the driving apparatus configured in this manner, an operation is checked by linking V_{f} fluctuation which accompanies a change in the voltage value of the voltage value variable DC power circuit 20 with fluctuation of the LED driving current value which accompanies a change in the current value variable constant current circuit 22, and a result can be fed back to the control value of the entire device.

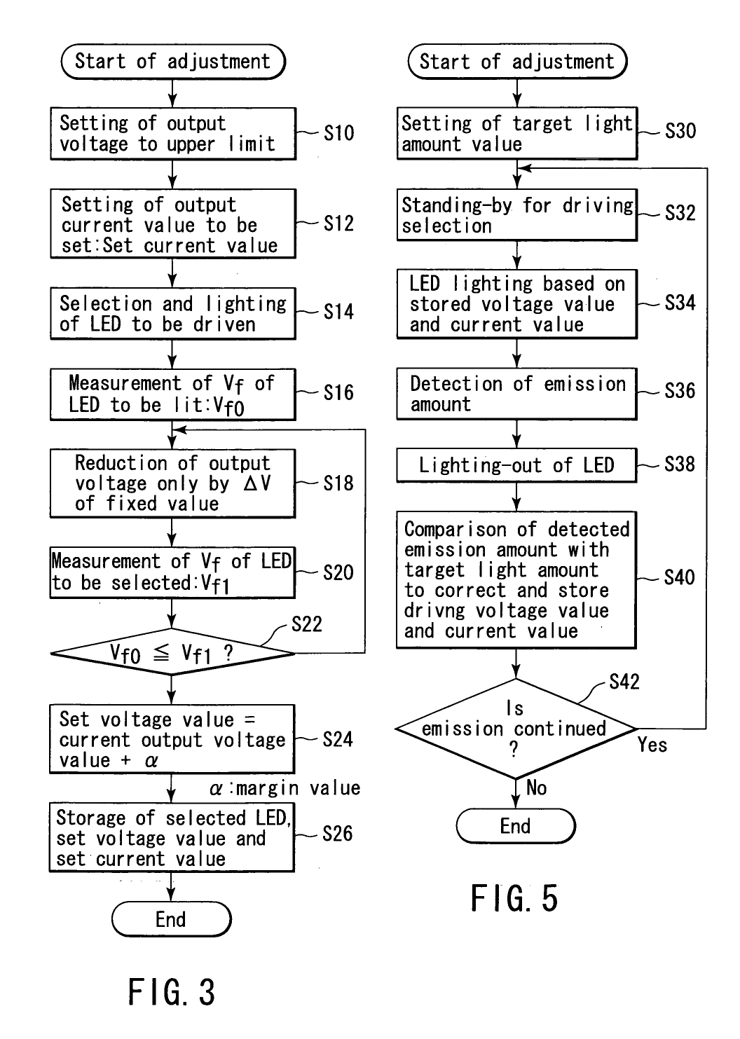

Even if load driving conditions are ambiguous at a designing stage or before use of the device, a control amount can be set by self-adjustment in the device. For example, as shown in FIG. 3, on an adjustment mode which is not normal use time, the LED lighting controller 18 first sets an output voltage of the voltage value variable DC power circuit 20 to an upper limit value (step S10). The LED lighting controller 18 sets an output current value of the current value variable constant current circuit 22 to a desired current value (step S12). Subsequently, the LED changeover SW 16 is controlled to select and light an LED to be driven (step S14). Then, V_{f} of the lit LED is measured by the detection unit 24, and a measured value is fetched as V_{f0} (step S16).

Next, an output voltage of the voltage value variable DC power circuit 20 is lowered by a fixed value (ΔV) (step S18). Then, V_{f} of the selected LED is measured by the detection unit 24, and a measured value is fetched as V_{f1} (step S20). Subsequently, the measured value V_{f0} fetched in step S16 is compared with the measured value V_{f1} fetched in step S20 (step S22). If V_{f0}≦V_{f1} is determined, the process returns to step S18 to repeat the aforementioned operation.

Thus, if it is determined in step S22 that the measured value V_{f1} is smaller than the measured value V_{f0}, a value obtained by adding a margin value α to the output voltage value at a point of this time is set as a voltage value (step S24). Then, this set voltage value and the current value set in step S12 are stored as set values for the selected LED in an internal memory (not shown) (step S26). By carrying out such an operation for each LED, it is possible to obtain current and voltage values of the load driving circuit 14 which are proper for driving each LED.

Therefore, by monitoring the V_{f} value at the detection unit 24 while changing the voltage value, it is possible to prestore the current and voltage values of the load driving circuit which are proper for driving the target LED.

Incidentally, according to Modified Embodiment 1, driving characteristics of each LED are detected. However, in the case of using many LEDs, it is not necessary to detect characteristics of all LEDs. In other words, if there are LEDs of similar characteristics, characteristics of only a representative LED may be detected.

[Modified Embodiment 2]

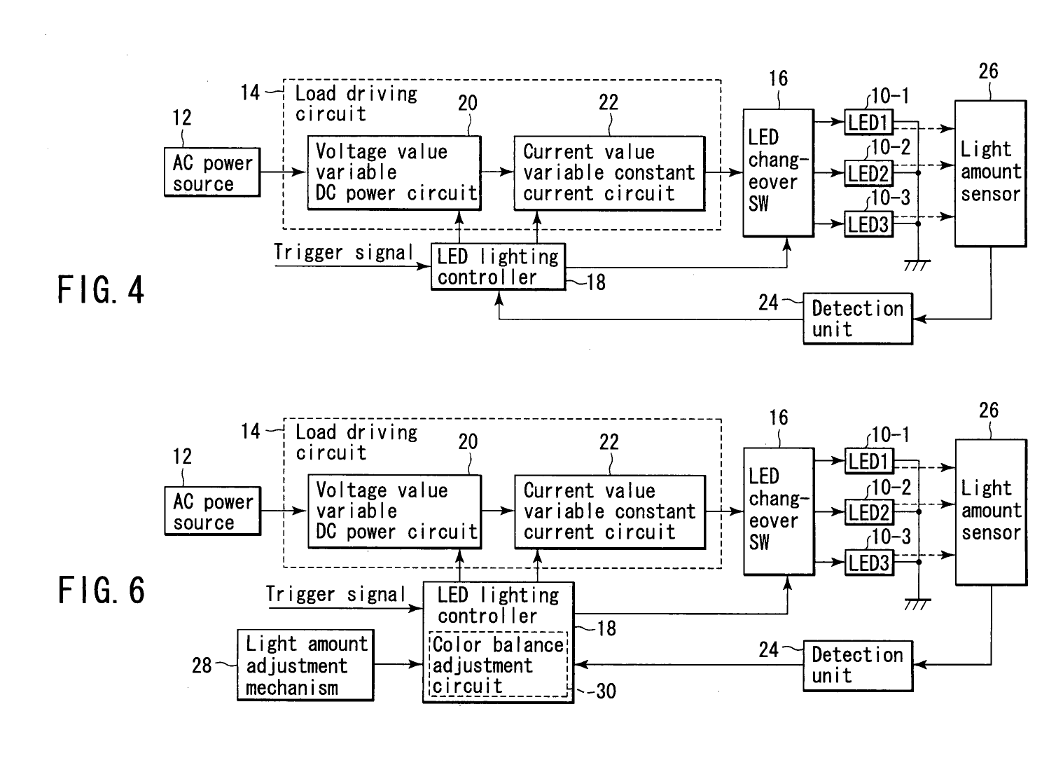

As a detection section which detects load characteristic information, a light sensor may be used to detect a light emitted from the LED. That is, in addition to the configuration of Modified Embodiment 1, Modified Embodiment 2 comprises a light amount sensor 26 which detects an emission amount of the LED as shown in FIG. 4. This light amount sensor 26 receives a light from each of the LEDs 10-1 to 10-3, and subjects the light to photoelectric conversion. As a representative sensor, a photodiode is known. According to Modified Embodiment 2, an analog amount obtained by photoelectric conversion at the light amount sensor 26 is converted into a digital amount at the detection unit 24, and an emission amount value as most important characteristics of the LED is fed back to the LED lighting controller 18. Then, the LED lighting controller 18 adjusts voltage and current values supplied from the load driving circuit 14 to the LED based on the feedback value of the emission amount.

FIG. 5 is an operation flowchart of the LED lighting controller 18 when while a normal operation of the lighting apparatus is carried out, control is executed by varying voltage and current values which are control values in real time based on the emission amount of the LED. This flowchart is specific to one LED. In reality, such an operation is carried out for each of the plurality of LEDs.

That is, first, a target light amount value decided beforehand at the device or optionally set by a user is set (step S30). Subsequently, the process stands by for driving selection of the LED (step S32).

Then, if driving selection timing of the LED is reached (step S32), the LED is lit to be driven by controlling the load driving circuit 14 and the LED changeover SW 16 as follows (step S34). That is, the load driving circuit 14 is controlled so as to obtain voltage and current values of the LED stored in the memory (not shown) of the LED lighting controller 18. In association, the LED changeover SW 16 is controlled so as to switch and select the LED. Accordingly, the LED is lit to be driven based on the voltage and current values. Subsequently, an emission amount of the LED is detected by the light amount sensor 26 and the detection unit 24 to be fetched (step S36). When next LED driving selection timing is reached, the operation of step S34 is executed for a next LED to switch the LED changeover SW 16. Thus, the light of the LED which has been subjected to the light amount detection is tuned OFF (step S38).

The detected emission amount is then compared with the target light amount set in step S30. In accordance with a result of the comparison, the driving voltage and current values are corrected to be stored as control values for the LED in the memory (not shown) (step S40). Subsequently, determination is made as to whether light emission is continued more or not (step S42). If the light emission is continued, the process returns to step S32. If the light emission is finished, this operation is finished. Incidentally, the light emission continuance is determined based on execution of an OFF-operation of a switch (not shown) to instruct an adjustment mode, an OFF-operation of a power switch of the device, or the like.

Thus, according to Modified Embodiment 2, the LED lighting controller 18 controls the load driving circuit 14 based on a feedback value of the emission amount, whereby the voltage and current values supplied from the load driving circuit 14 to the LED can be controlled when necessary. Therefore, it is possible to maintain the emission amount of each LED in a stable state. Moreover, it is possible to supply a stable emission amount even at initial lighting time of the LED, and to deal with deterioration with an elapse of a long period of time.

[Modified Embodiment 3]

As shown in FIG. 6, it is possible to employ a configuration in which a light amount adjustment mechanism 28 is added to the configuration of Modified Embodiment 2, and a color balance adjustment circuit 30 is disposed in the LED lighting controller 18 to enable varying of an emission amount by an external operation.

In this case, the LEDs 10-1 to 10-3 are individual LEDs of R, G, B which are different emission colors. The LEDs 10-1 to 10-3 are different from one another in increases/decreases of emission amounts with respect to a driving current and V_{f} changing characteristics. FIG. 7 is a view showing a relation between a driving current I and an emission amount L by each of R, G, B colors of the LED, and FIG. 8 is a view showing a relation between a driving current I_{f} and V_{f} by each of R, G, B colors of the LED. As can be understood from the drawings, characteristics vary from color to color. Thus, color balance is broken if the driving current is changed across the board in accordance with an operation of the light amount adjustment mechanism 28.

Thus, an emission amount of each of the LEDs 10-1 to 10-3 is measured by the light amount sensor 26, and the measured value is processed by the color balance adjustment circuit 30 to calculate voltage and current values supplied to the load driving circuit 14. As a result, it is possible to vary an emission amount linearly while maintaining color balance in accordance with the operation of the light amount adjustment mechanism 28.

Next, each section which constitutes the driving apparatus of the embodiment will be described more in detail.

[LED Lighting Controller 18]

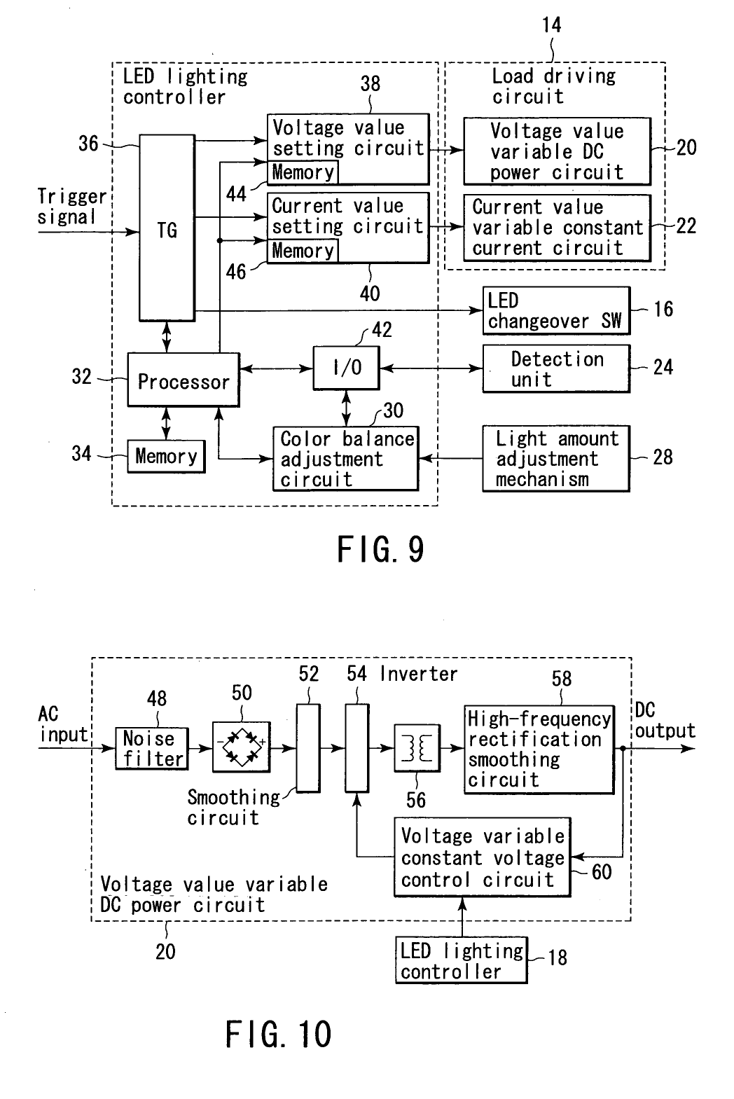

As shown in FIG. 9, the LED lighting controller 18 that is a control section of the driving apparatus of the embodiment comprises a processor 32, a system memory 34, a TG 36, a voltage value setting circuit 38, a current value setting circuit 40, and an I/O 42 in addition to the color balance adjustment circuit 30.

The processor 32 controls each section in the LED lighting controller 18 in accordance with a control program or the like stored in the system memory 34. The system memory 34 stores data measured by the detection unit 24. Further, the system memory 34 functions as memories in step S26 shown in FIG. 3 of Modified Embodiment 1 and in step S40 shown in FIG. 5 of Modified Embodiment 2. In the case of the configuration of Modified Embodiment 3, the system memory 34 stores LED I-V_{f} characteristics and I-L characteristics similar to those shown in FIGS. 7 and 8. In other words, the system memory 34 functions as a characteristic memory section.

The TG 36 is a timing generator which generates timing for switching set voltage and current values of the load driving circuit 14, and a selection control signal (digital signal of several bits) to the LED changeover SW 16 by using an input trigger signal as reference timing. The switching timing is set so as to be changed based on data from the processor 32. The TG 36 generates the timing while measuring a high-speed clock signal exclusive for the processor 32 or the TG. Operation timing can be varied by changing a counter value thereof. In the case of using a lighting apparatus which uses the driving apparatus of the embodiment for a display apparatus, a vertical or horizontal synchronous signal of a video signal can be used as the trigger signal.

The voltage value setting circuit 38 sets a voltage value to be supplied by the voltage value variable DC power circuit 20 of the load driving circuit 14. This voltage value setting circuit 38 has a memory 44 which stores data of a plurality of voltage values switched in one sequence repeated at a high speed. The voltage value setting circuit 38 supplies a value stored in the memory 44 as digital data to the voltage value variable DC power circuit 20 in synchronization with control signal timing from the TG 36. A set value of the memory 44 can be changed by the processor 32. Thus, control data for setting the output voltage value of the voltage value variable DC power circuit 20 can be changed by switching the data read from the memory 44. In other words, the output voltage value of the voltage value variable DC power circuit 20 can be changed without being passed through the processor 32. Thus, changing control can be executed at a high speed.

The current value setting circuit 40 is substantially similar in configuration to the voltage value setting circuit 38. However, switching timing is controlled independently by the TG 36. By this current value setting circuit 40, control data for setting a current value to be supplied by the current value variable constant current circuit 22 of the load driving circuit 14 can be switched based on data read from a memory 46. In other words, the current value of the current value variable constant current circuit 22 can be changed without being passed through the processor 32. Thus, changing control can be executed at a high speed.

The I/O 42 is a circuit which inputs a detected value from the detection unit 24 to the processor 32 or the color balance adjustment circuit 30. The color balance adjustment circuit 30 is disposed in the case of the configuration of Modified Embodiment 3. This color balance adjustment circuit 30 cooperates with the processor 32 to calculate voltage and current values of the load driving circuit 14 for adjusting a light amount in consideration of color balance based on LED characteristic data stored in the system memory 34, light amount measurement data input through the I/O 42, and a variable amount input by the light amount adjustment mechanism 28 at a high speed.

[Voltage Value Variable DC Power Circuit 20]

According to the embodiment, the voltage value variable DC power circuit 20 that is a part of the load driving circuit 14 is a switching power source of AC-DC conversion in which an output voltage value is fed back to stabilize an output value. That is, as shown in FIG. 10, the voltage value variable DC power circuit 20 converts an AC input voltage from the AC power source 12 into a DC voltage by a rectification circuit 50 after noise removal through a noise filter 48. Further, the DC voltage obtained by the conversion is smoothed by a smoothing circuit 52, converted into an AC voltage by an inverter 54, applied to a high-frequency transformer 56 to be boosted, and converted into a DC voltage by a high-frequency rectification smoothing circuit 58 to obtain a DC output. This output voltage value is fed back to the inverter 54 by a voltage variable constant voltage control circuit 60. A feedback amount by the voltage variable constant voltage control circuit 60 is subjected to external control by the LED lighting controller 18 to be varied, whereby the output voltage value can be varied.

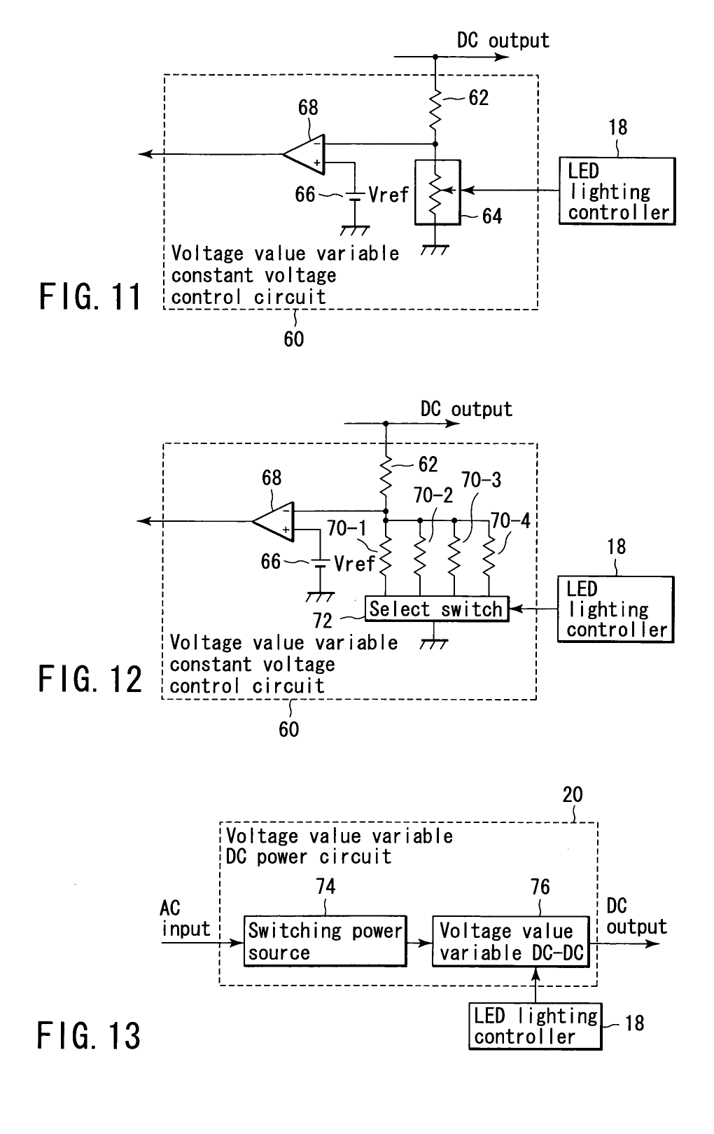

As shown in FIG. 11, the voltage variable constant voltage control circuit 60 compares a voltage value obtained by voltage division by a resistor 62 and a digital potentiometer 64 connected between the DC output and a ground (referred to as GND, hereinafter) with a voltage of a reference voltage source 66 at a comparator 68. An output of the comparator 68 is supplied to the inverter 54.

That is, the DC output value can be controlled by setting a resistance value Rp of the digital potentiometer 64 which is set by the LED lighting controller 18. Thus, fine voltage setting is enabled by a gray scale of the digital potentiometer 64. A DC voltage Vₒᵤₜ is calculated by the following equation:

Vₒᵤₜ=V_{ref}*(R₀+Rₚ)/Rₚ

wherein R₀ is a resistance value of the resistor 62, and V_{ref} is a voltage value of the reference voltage source 66.

Additionally, the voltage variable constant voltage control circuit 60 may be configured as shown in FIG. 12. According to this configuration, the digital potentiometer 64 is replaced by a plurality of resistors 70-1 to 70-4, and a select switch 72 for selecting the resistors. The select switch 72 switches the resistors 70-1 to 70-4 in accordance with selection by the LED lighting controller 18. According to the configuration, it is possible to control a discrete DC output voltage-Vₒᵤₜ based on setting of the select switch 72 which makes selection.

Furthermore, as shown in FIG. 13, the voltage value variable DC power circuit 20 may comprise a switching power source 74, and a voltage value variable DC-DC converter 76 which can vary an output voltage value at a high speed. For example, the switching power source 74 can comprise sections similar to those from the noise filter 48 to the high-frequency rectification smoothing circuit 58 shown in FIG. 10. Then, a DC output voltage of the switching power source 74 can be varied by the voltage value variable DC-DC converter 76 under control of the LED lighting controller 18.

[Current Value Variable Constant Current Circuit 22]

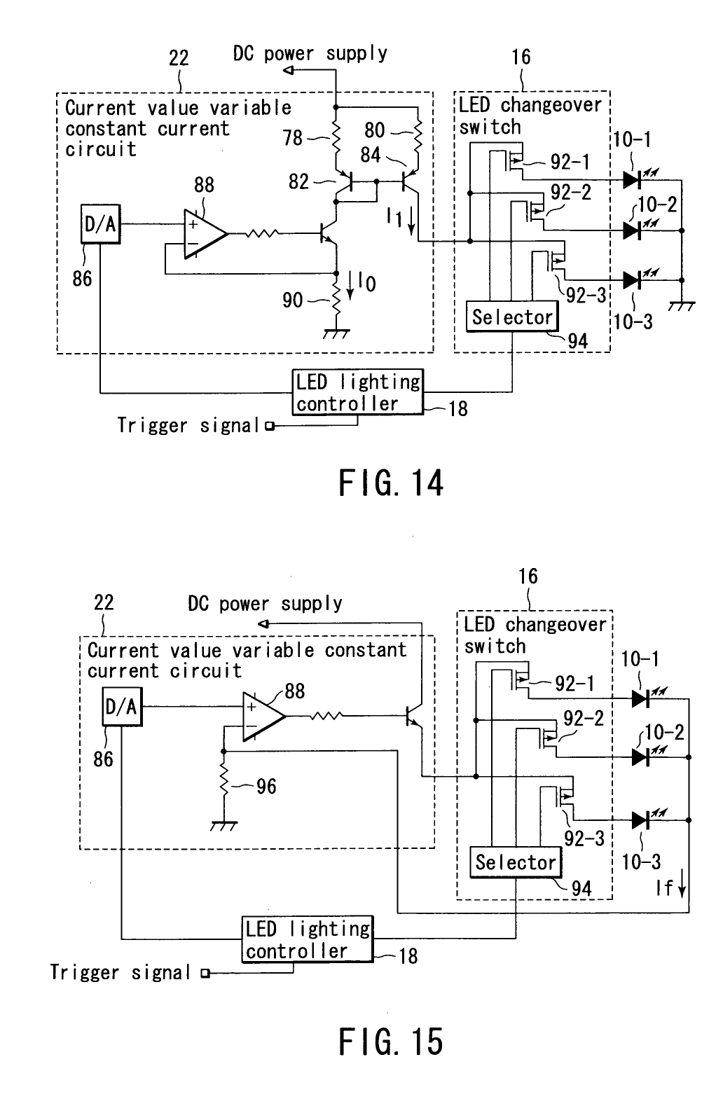

FIG. 14 is a circuit diagram showing a configuration of the current value variable constant current circuit 22 which is a part of the load driving circuit in the driving apparatus of the embodiment. In the drawing, a DC power supply is a DC output of the voltage value variable DC power circuit 20. That is, the current value variable constant current circuit 22 is a circuit based on a current mirror circuit which comprises resistors 78, 80, and transistors 82, 84. Here, an LED driving current I₁ is decided based on I₀ decided by a set value R_{ref} supplied from the LED lighting controller 18 through a D/A converter 86 to a non-inversion input terminal of an OP amplifier 88 and the detection resistor 78, and a ratio of a resistor 80 and a resistor 90. In other words, a current set value is set by the following equations:

I₀=V_{ref}/R₀

I₁=I₀*(R₁/R₂)

wherein R₀ is a resistance value of the detection resistor 78, R₁ is a resistance value of the resistor 80, and R₂ is a resistance value of the resistor 90.

The driving current I₁ set in the above manner is selectively supplied to each of the LEDs 10-1 to 10-3 through the LED changeover SW 16 which comprises MOSFETs 92-1 to 92-3 and a selector 94.

Additionally, the current value variable constant current circuit 22 may be configured as shown in FIG. 15. This current value variable constant current circuit 22 is a circuit based on a feedback system which uses the OP amplifier 88 and the detection resistor 90. In this case, an LED driving current If is set by the following equation based on a set value V_{ref} of the D/A converter 86 and a resistance value R of the detection resistor 90:

I_{f}=V_{ref}/R

[Detection Unit 24]

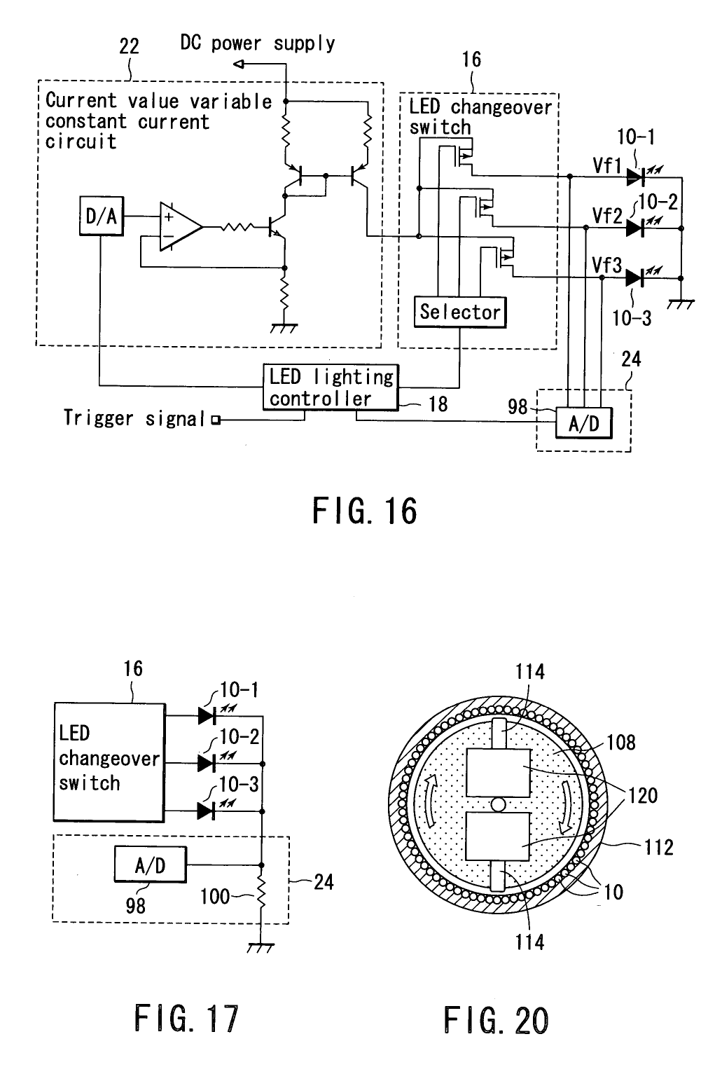

FIG. 16 is a view showing a specific example of the detection unit 24 in the case of Modified Embodiment 1 shown in FIG. 2. That is, the detection unit 24 comprises an A/D converter 98 which converts V_{f} values of the LEDs 10-1 to 10-3 into digital values. The digital values obtained by the conversion at the A/D converter 98 are supplied to the LED lighting controller 18. The LED lighting controller 18 sets various control data again based on the digital values.

If the current value variable constant current circuit 22 comprises the current mirror circuit as shown in FIG. 14, the detection unit 24 may be configured as shown in FIG. 17. That is, a voltage value generated at a current detection resistor 100 inserted between the LEDS 10-1 to 10-3 and the GND is subjected to digital conversion at the A/D converter 98 to be supplied to the LED lighting controller 18.

[Second Embodiment]

Next, a second embodiment of the present invention will be described. A driving apparatus of the embodiment and a lighting apparatus that uses the same are similar in configuration to those of the first embodiment, and thus description thereof will be omitted. According to the second embodiment, setting of a voltage value by a voltage value variable DC power circuit 20 of a load driving circuit 14, and setting of a current value by a current value variable constant current circuit 22 of the load driving circuit 14 are carried out at different timings.

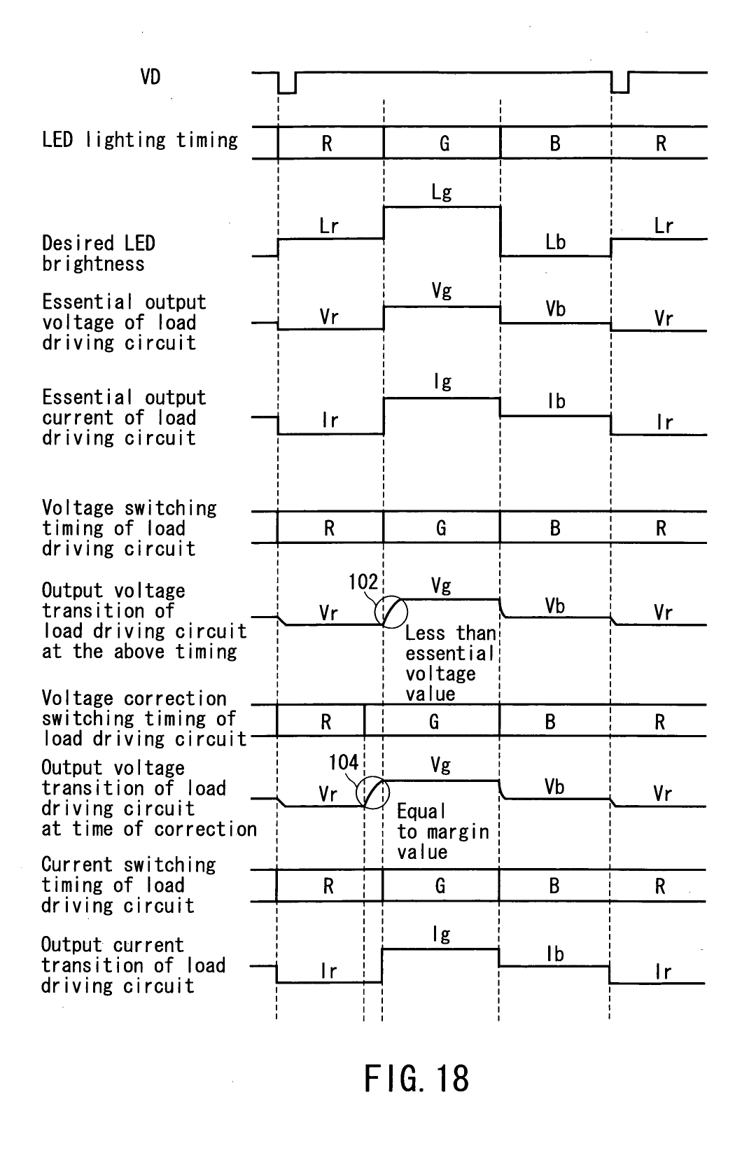

FIG. 18 is a view showing driving timing of an RGB-LED lighting apparatus used for a field sequential color display apparatus of a frame frequency 120 Hz. That is, LEDs of R, G, B are sequentially lit by one cycle of a trigger signal VD based on a video signal. In connection with this, according to the first embodiment, in order to obtain desired brightness Lr, Lg, Lb, the essential output voltage of the voltage value variable DC power circuit 20 and the essential output current of the current value variable constant current circuit 22 are decided in accordance with characteristics of each LED, the driving is executed in such a manner, and the LED is switched in accordance with the voltage switching timing. In such a case, as shown in a waveform “output voltage transition of load driving circuit at the above timing” of FIG. 18, delay time occurs in real voltage value switching at the voltage value variable DC power circuit 20. Consequently, in a period of a ; mark 102 in the drawing, a light amount of a target load LED is different from desired brightness.

Thus, according to the second embodiment, voltage value switching timing of the voltage value variable DC power circuit 20 is corrected as shown in a waveform “voltage correction switching timing of load driving circuit” of FIG. 18. That is, voltage value switching timing is quickened when the LED of an R color is switched to the LED of a G color. When the LED of the G color is switched to the LED of a B color, and the LED of the B color is switched to the LED of the R color, delay time or a brightness difference poses no problem because of a voltage value lowering direction. Thus, the switching timing thereof is not corrected. By correcting the voltage value switching timing in the above manner, it is possible to prevent operation fluctuation of the load LED caused by the voltage value switching delay time in the voltage value variable DC power circuit 20. Incidentally, in a period of a ; mark 104 in the drawing, there is a spare voltage, and this spare voltage is consumed as heat.

On the other hand, regarding current value switching, since no delay time occurs to affect the light amount of the LED, switching timing of the current value variable constant current circuit 22 of the load driving circuit 14 is similar to that of the first embodiment.

[Third Embodiment]

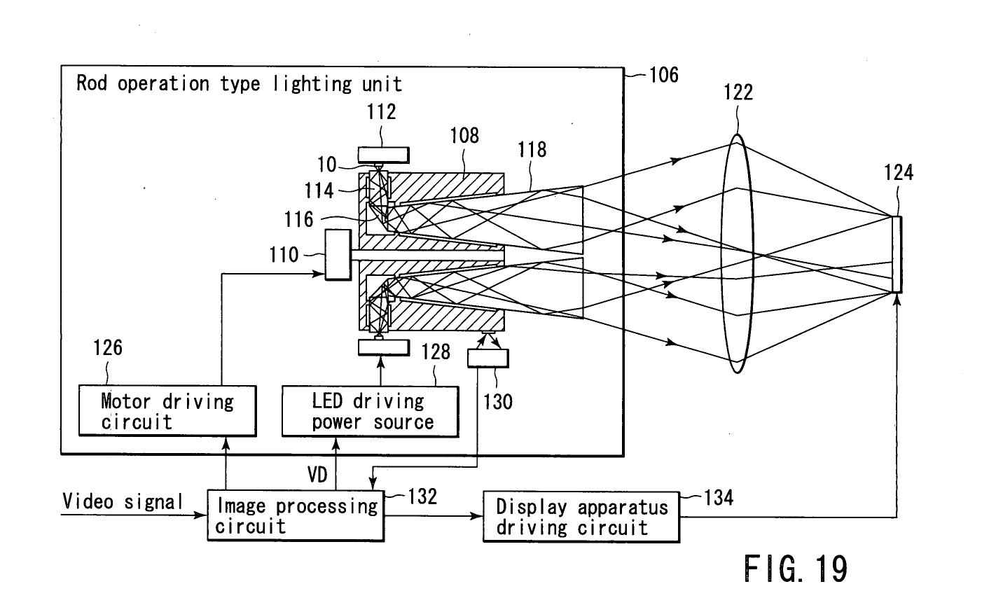

Next, a third embodiment of the present invention will be described. The embodiment is a display apparatus which uses the driving apparatus of the first or section embodiment and the lighting apparatus using the same. FIG. 19 is a view showing a configuration of a display apparatus which uses a rod operation type lighting unit 106 using a plurality of LEDs 10. FIG. 20 is an outline view in which the rod operation type lighting unit 106 of FIG. 19 is seen from a stacked lens side.

That is, in the rod operation type lighting unit 106, two square light guide rod members constituted of L-shaped optical surfaces are attached to a rod holder 108 which is a rotatable holder. This rod holder 108 is rotated by a motor 110 to rotate the two light guide rod members. A plurality of LEDs 10 arrayed close to one another as light emitters on an inner periphery of a drum-shaped LED substrate 112. These LEDs 10 are sequentially lit by one or two for each light guide rod member in accordance with rotation thereof. Incidentally, the light guide rod member is square-shaped because since the LED 10 is rectangular, a similar shape provides high efficiency, and a loss when it is bent in an L shape is limited to a minimum. The L-shaped light guide rod member is formed by bonding three components, i.e., a square parallel rod 114, a reflection prism 116 in which reflection coating is applied on a slope for bending an optical path, and a taper rod 118. Needless to say, the light guide rod member may be manufactured by integral molding.

Additionally, the rod operation type lighting unit 106 is positioned with respect to the stacked lens 122 and a display device 124 so as to configure Koehler lighting optical system in which an optical pupil is formed on the display device 124 by the stacked lens 122 while an emission end face of the light guide rod member (emission end face 120 of the taper rod 118) is set as a virtual light source.

The motor 110 is driven by a motor driving circuit 126, and the LED 10 is driven by an LED driving power source 128 equivalent to the driving apparatus of the invention. In this case, the LED driving power source 128 controls emission timing of the LED 10 based on rotational position detection of the rod holder 108 by a rotation sensor 130. The motor driving circuit 126 and the LED driving power source 128 are controlled based on a signal from an image processing circuit 132 which processes a video signal to be displayed.

Thus, the plurality of LEDs 10 are sequentially switched to emit pulses, and a relative positional relation with the light guide rod member for fetching a radiated light is selected in accordance with the emission switching of the LED 10 to be changed. Accordingly, an LED of effectively high luminance is obtained, and a light of a large amount and improved parallelism is obtained from the light guide rod member.

For the display device 124, a transmissive LCD, a reflective LCD or a 2-dimensional micromirror deflection array known as a trademark of a digital micromirror device (DMD) can be used. The DMD (trademark) is disclosed in, e.g., Jpn. Pat. Appln. KOKAI Publication No. 11-32278 or U.S. Pat. No. 6,129,437, and thus description thereof will be omitted. The display device 124 is driven by a display device driving circuit 134 in accordance with the video signal processed by the image processing circuit 132.

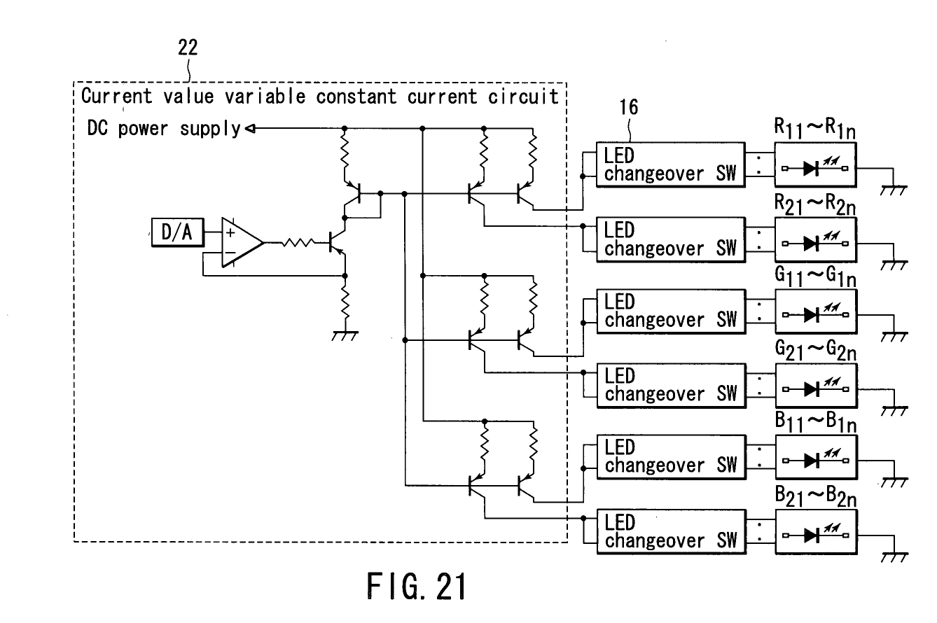

FIG. 21 is a view showing a connection circuit between a part of the LED driving power source 128 used in the display apparatus of FIG. 19 and a load LED. That is, the display apparatus fetches lights from two or more LEDs 10 arranged in opposing positions to simultaneously emit lights, and guides the lights by the two light guide rod members. Thus, the LED driving power source 128, i.e., the current value variable constant current circuit 22 of the driving apparatus of the invention, comprises a multiple output current mirror circuit so that the two LEDs of R, G, B colors can be simultaneously driven by the same current value.

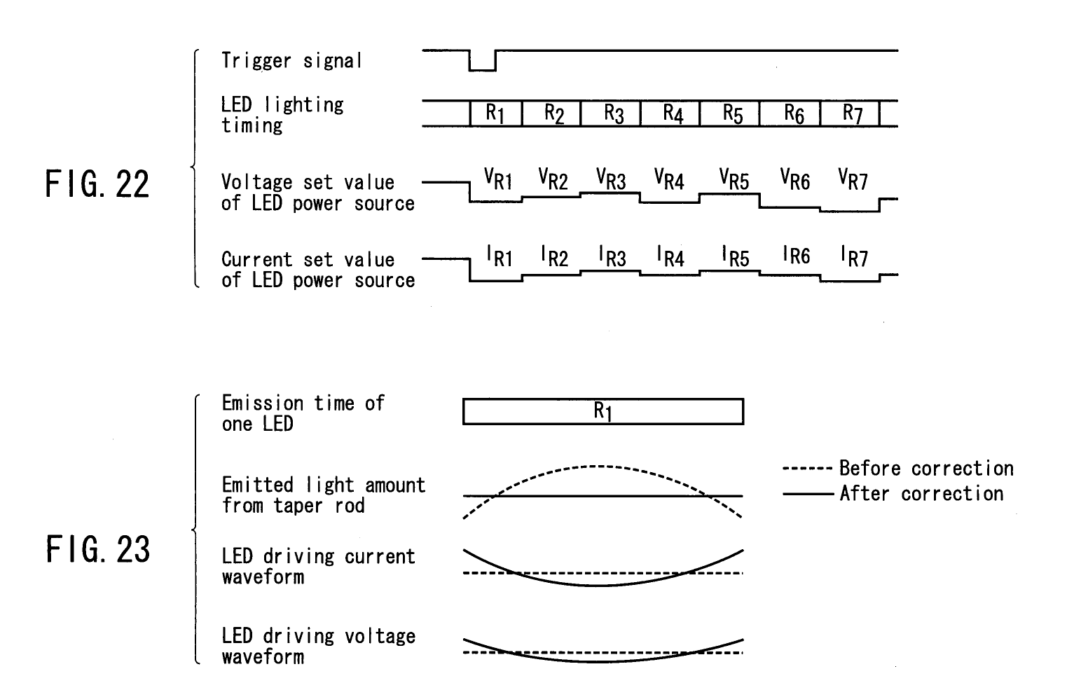

Furthermore, FIG. 22 is a timing chart showing a control state in a period in which the LED of the R color of the LED driving power source 128 used in the display apparatus of FIG. 19 emits a light. This shows that voltage and current values are controlled for each LED to stabilize an emitted light amount. In the drawing, voltage and current values are different between adjacent LEDs. However, the voltage and current values are not limited to such, and may be set to equal control values.

[Modified Embodiment]

FIG. 23 is a timing chart specific to one LED of FIG. 22. In the rod operation type lighting unit 106 of FIG. 19, the movement of the light guide rod member is accompanied by a change in opposing areas of the parallel rod 114 and one LED 10. Consequently, as shown in “emitted light amount from taper rod” of FIG. 23, the amount of a light emitted from an emission end of the taper rod 118 is changed with time. Thus, the LED driving power source 128, i.e., the driving apparatus, executes control so as to make an LED driving current waveform and an LED driving voltage waveform similar to waveforms indicated by solid lines in FIG. 23. As a result, it is possible to eliminate such a change with time in the light amount.

The preferred embodiments of the present invention have been described. Needless to say, however, the embodiments are not limitative of the invention, and various modifications and applications can be made within the scope of the teachings of the invention.

For example, as load characteristics obtained before the switching of the load conditions for driving the load, not only the V_{f}, the LED driving current value and the light amount described above in the embodiments but also other characteristics such as an amount of generated heat and an atmospheric temperature can be included.

Needless to say, the load is not limited to an LED.

Furthermore, if the display apparatus that uses the lighting apparatus of the invention is applied to an image projection component in, e.g., a picture exposing apparatus, a color copying machine, a color printer, a rewritable electronic paper recorder or the like, color adjustment is facilitated to provide effective image formation means.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A driving apparatus which drives a load by switching driving conditions with time, comprising:
a load driving section configured to drive the load by supplying a voltage and a current;
a switching section configured to switch conditions of the load driven by the load driving section; and
a control section configured to obtain load characteristic information after switching by the switching section before the switching, and to set a voltage and a current by which the load driving section drives the load to a voltage and a current corresponding to the load characteristic information after the switching in synchronization with timing of the switching.

2. The apparatus according to claim 1, wherein:
the load comprises a plurality of loads; and
the switching section switches the plurality of loads with time.

3. The apparatus according to claim 1, wherein:
the load comprises one load; and
the switching section switches one load between presence and nonpresence.

4. The apparatus according to claim 1, wherein the load is an LED.

5. The apparatus according to claim 4, wherein the characteristic information contains a V_{f} value when a predetermined current amount is supplied to the LED.

6. The apparatus according to claim 4, wherein the characteristic information contains an emission amount when a predetermined current amount is supplied to the LED.

7. The apparatus according to claim 1, further comprising:
a detection section configured to detect the characteristic information.

8. The apparatus according to claim 7, wherein
the load is an LED, and
the detection section includes a light sensor configured to detect a light emitted from the LED.

9. The apparatus according to claim 1, wherein the control section has a characteristic memory section configured to store the characteristic information.

10. The apparatus according to claim 9, wherein
the load is an LED, and
the characteristic memory section stores a predetermined emission amount of the LED corresponding to a current value supplied to the LED.

11. The apparatus according to claim 4, wherein the control section sets a current value and a voltage value of the load driving section at different timings.

12. The apparatus according to claim 4, wherein the control section sets a voltage value of the load driving section before predetermined time of the switching timing if the voltage value of the load driving section after the switching timing is larger than that of the same before the switching timing.

13. The apparatus according to claim 12, wherein the predetermined time corresponds to power source response time.

14. A lighting apparatus which lights a display device displayed by a video signal, comprising:
a driving apparatus which drives a load by switching driving conditions with time, including:
a load driving section configured to drive the load by supplying a voltage and a current;
a switching section configured to switch conditions of the load driven by the load driving section; and
a control section configured to obtain load characteristic information after switching by the switching section before the switching, and to set a voltage and a current by which the load driving section drives the load to a voltage and a current corresponding to the load characteristic information after the switching in synchronization with timing of the switching; and
a light emitter configured as a load driven by the load driving section to light the display device, wherein
the switching section selects the light emitter driven in synchronization with timing of the video signal.

15. The apparatus according to claim 14, wherein the light emitter includes an LED.

16. The apparatus according to claim 14, wherein the timing of the video signal is a video synchronous signal.

17. A display apparatus comprising:
a display device configured to display a video by a video signal; and
a lighting apparatus which lights the display device, including:
a driving apparatus which drives a load by switching driving conditions with time, having:
a load driving section configured to drive the load by supplying a voltage and a current;
a switching section configured to switch conditions of the load driven by the load driving section; and
a control section configured to obtain load characteristic information after switching by the switching section before the switching, and to set a voltage and a current by which the load driving section drives the load to a voltage and a current corresponding to the load characteristic information after the switching in synchronization with timing of the switching; and
a light emitter configured as a load driven by the load driving section to light the display device, wherein
the switching section selects the light emitter driven in synchronization with timing of the video signal.

18. The apparatus according to claim 17, wherein the display device includes an LCD.

19. The apparatus according to claim 17, wherein the display device includes a DMD (trademark).

20. A driving apparatus which drives a load by switching driving conditions with time, comprising:
load driving means for driving the load by supplying a voltage and a current;
switching means for switching conditions of the load driven by the load driving means; and
control means for obtaining load characteristic information after switching by the switching means before the switching, and setting a voltage and a current by which the load driving means drives the load to a voltage and a current corresponding to the load characteristic information after the switching in synchronization with timing of the switching.

21. A lighting apparatus which lights a display device displayed by a video signal, comprising:
a driving apparatus which drives a load by switching driving conditions with time, including:
load driving means for driving the load by supplying a voltage and a current;
switching means for switching conditions of the load driven by the load driving means; and
control means for obtaining load characteristic information after switching by the switching means before the switching, and setting a voltage and a current by which the load driving means drives the load to a voltage and a current corresponding to the load characteristic information after the switching in synchronization with timing of the switching; and
light emitting means, as a load driven by the load driving means, for lighting the display device, wherein
the switching means selects the light emitting means driven in synchronization with timing of the video signal.

22. A display apparatus comprising:
a display device configured to display a video by a video signal; and
a lighting apparatus which lights the display device, including:
a driving apparatus which drives a load by switching driving conditions with time, including:
load driving means for driving the load by supplying a voltage and a current;
switching means for switching conditions of the load driven by the load driving means; and
control means for obtaining load characteristic information after switching by the switching means before the switching, and setting a voltage and a current by which the load driving means drives the load to a voltage and a current corresponding to the load characteristic information after the switching in synchronization with timing of the switching; and
light emitting means, as a load driven by the load driving means, for lighting the display device, wherein
the switching means selects the light emitting means driven in synchronization with timing of the video signal.
